(19) United States
(12) Patent Application Publication
(10) Pub. No.: US 2025/0272205 A1
(43) Pub. Date: Aug. 28, 2025

(54) COLLECTION OF BMC AND SYSTEM APPLICATION HEALTH PARAMETERS AND CREATION OF A CORRELATED DATA MODEL FOR ANALYTICS

(71) Applicant: American Megatrends International, LLC, Duluth, GA (US)

(72) Inventors: Chitrak Gupta, Kolkata (IN); J. Vinodhini, Chennai (IN); Venkatesan Balakrishnan, Chennai (IN); Anurag Bhatia, Sugar Hill, GA (US)

(21) Appl. No.: 18/584,316

(22) Filed: Feb. 22, 2024

(51) Int. Cl. G06F 11/30; H04L 9/32

(52) U.S. Cl. CPC G06F 11/3051; G06F 11/3433; G06F 11/3452; H04L 9/3247; H04L 41/16; H04L 43/08

(57) ABSTRACT

A BMC collects at least one of: data related to one or more processes executed on the BMC, data related to one or more processes executed on a host coupled to the BMC, data related to resource allocation at the BMC, data related to resource allocation at the host, fault statistics at the BMC, fault statistics at the host, network statistics at the BMC, network statistics at the host, hardware sensor data at the BMC, and hardware sensor data at the host. The BMC aggregates the collected data into a consolidated data set. The BMC transmits the consolidated data set to a management system. The BMC receives instructions from the management system to adjust operational parameters of at least one of the BMC and the host. The BMC adjusts the operational parameters based on the received instructions.

### BACKGROUND

### Field

The present disclosure relates generally to computer systems, and more particularly, to techniques of collection of baseboard management controller (BMC) and system application health parameters and creation of a correlated data model for analytics.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture. The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a BMC. The BMC collects at least one of: data related to one or more processes executed on the BMC, data related to one or more processes executed on a host coupled to the BMC, data related to resource allocation at the BMC, data related to resource allocation at the host, fault statistics at the BMC, fault statistics at the host, network statistics at the BMC, network statistics at the host, hardware sensor data at the BMC, and hardware sensor data at the host. The BMC aggregates the collected data into a consolidated data set. The BMC transmits the consolidated data set to a management system. The BMC receives instructions from the management system to adjust operational parameters of at least one of the BMC and the host. The BMC adjusts the operational parameters based on the received instructions.

In an aspect of the disclosure, a method, a computer-readable medium, and an management system are provided. The management system receives a consolidated data set from a BMC, the consolidated data set including at least one of data related to one or more processes executed on the BMC, data related to one or more processes executed on a host coupled to the BMC, data related to resource allocation at the BMC, data related to resource allocation at the host, fault statistics at the BMC, fault statistics at the host, network statistics at the BMC, network statistics at the host, hardware sensor data at the BMC, and hardware sensor data at the host. The management system analyzes the consolidated data set to determine whether to adjust operational parameters of at least one of the BMC and the host. The management system, in response to determining that the operational parameters require adjustment, generates instructions for adjusting the operational parameters. The management system transmits the instructions to the BMC.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system.

FIG. 2 is a diagram illustrating processes running on a BMC and a host.

FIG. 3 is a diagram illustrating data collection and aggregation.

FIG. 4 is a diagram illustrating a management cloud for data collection, aggregation, and correlation.

FIG. 5 is a diagram illustrating an exemplary REDFISH metric report.

FIG. 6 (A) is a diagram illustrating an example of a data frame.

FIG. 6 (B) is a diagram illustrating visualization of the aggregated data and correlations between parameters.

FIG. 7 is a diagram illustrating device management and control.

FIG. 8 is a flow chart of a method for managing a computer system.

FIG. 9 is a flow chart of another method for managing a computer system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

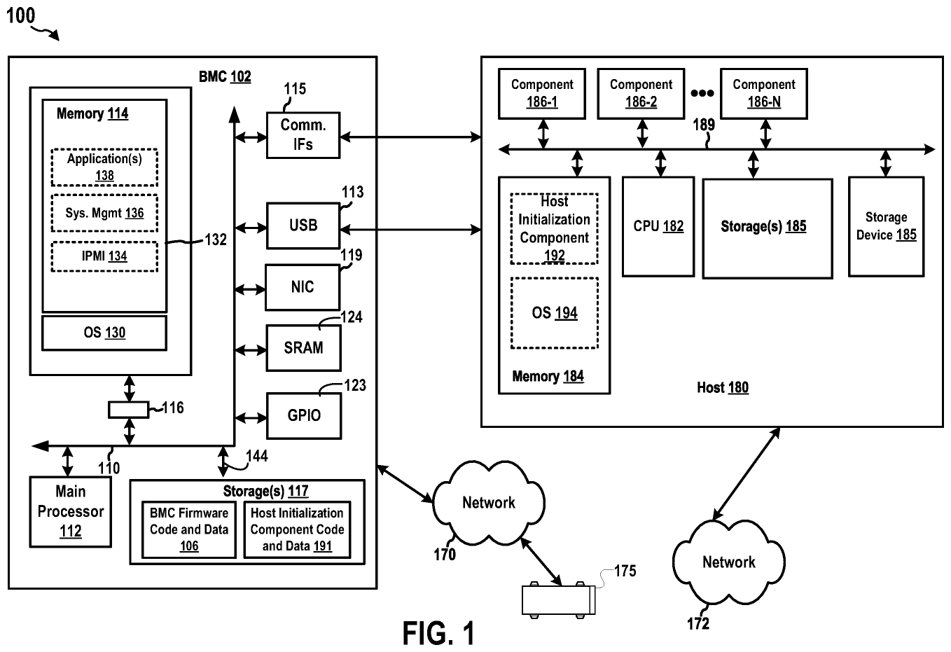

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface). The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170. Further, the storage(s) 117 is in communication with the communication channel 110 through a communication link 144.

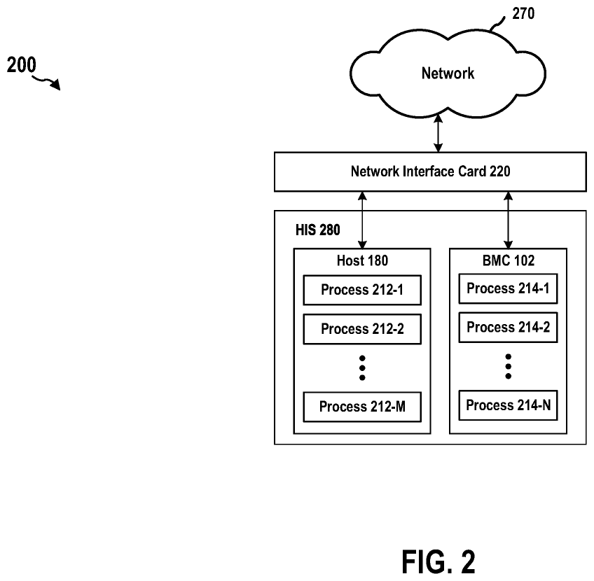

FIG. 2 is a diagram 200 illustrating processes running on the BMC 102 and the host 180. In this example, host processes 212-1 to 212-M are running on the host 180. BMC processes 214-1 to 214-N are running on the BMC 102. Further, the host 180 and the BMC 102 may share a network interface card (NIC) 220 to access a network 270.

Traditionally, BMCs have provided sensor information through interfaces such as IPMI or REDFISH, but do not provide visibility into the health and resource utilization of software processes running on the BMC and host.

For example, the BMC 102 and host 180 run various processes (BMC processes 214-1 to 214-N and host processes 212-1 to 212-M). However, there is no existing methodology to model and correlate the resource utilization and health of these processes with the underlying hardware components such as the CPU, memory, I/O, and sensors.

For example, when there is contention for shared hardware resources such as the NIC 220 between host and BMC processes, or when software processes start consuming higher resources, it impacts hardware parameters like temperature, power usage, cooling requirements etc.

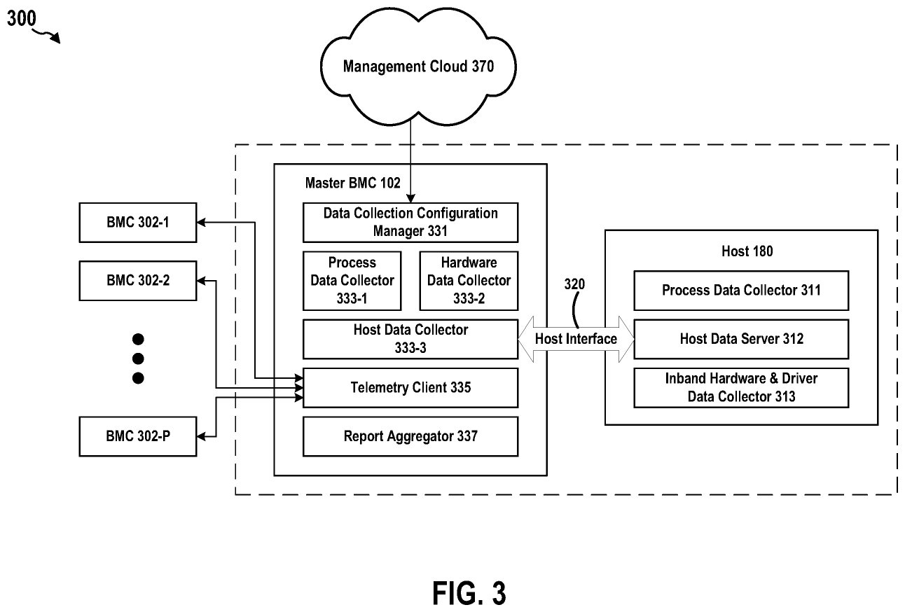

FIG. 3 is a diagram 300 illustrating data collection and aggregation. In this example, the service components 132 on the BMC 102 further includes a data collection configuration manager 331, a BMC process data collector 333-1, a BMC hardware data collector 333-2, a host data collector 333-3, a telemetry client 335, and a report aggregator 337. In addition, a host process data collector 311, a host data server 312, inband hardware data collection and drivers 313 are running on the host 180. The host data collector 333-3 on the BMC 102 and the host data server 312 on the host 180 are in communication through a host interface 320. Furthermore, the telemetry client 335 on the BMC 102 is in communication with BMCs 302-1 to 302-P. The data collection configuration manager 331 is in communication with a management cloud 370.

The management cloud 370 provides mechanisms to model the correlation between software resources and hardware resources including:
Process states (runtime) of BMC processes 214-1 to 214-N and host processes 212-1 to 212-M;
Process resource utilization such as CPU, memory, I/O of BMC and host processes;
Process fault statistics such as out of memory errors, crashes, restarts of BMC and host processes;
Hardware parameters such as CPU temperature, power usage, fan speeds; and
Network statistics when there is contention between host and BMC processes for shared NIC 220.

For example, when software processes start consuming higher resources due to issues such as memory leaks, it can impact hardware parameters such as temperature and power usage, as the CPU has to work harder. Similarly, contention between host and BMC processes for shared NIC 220 can affect network statistics.

By modeling and correlating process health/utilization data from host 180 and BMC 102 with underlying hardware sensors, the management cloud 370 may provide a holistic view of system health and enable better predictive and proactive management. The aggregated data can be used to tune performance, optimize resource allocation between host and BMC, debug abnormal behaviors, calculate cost analysis when certain processes run on the host 180, adjust hardware parameters based on software behavior, and enable closed loop remediations, etc.

More specifically, the BMC 102 may collect information about the resource utilization (e.g., CPU, memory, I/O) and health of the BMC processes 214-1 to 214-N and host processes 212-1 to 212-M. For example, when a new BMC application or feature is introduced, it may start consuming excessive resources. By monitoring the CPU and memory usage of the BMC processes 214-1 to 214-N, abnormal behavior can be detected. Thresholds can be set for CPU and memory utilization per process (e.g., 5-10%). If a process exceeds the threshold usage, it can be automatically restarted to avoid potential denial of service situations.

By modeling and correlating process resource utilization with underlying hardware components, issues can be identified before they cause larger problems. Appropriate actions, like restarting processes or reallocating resources, can then be taken automatically through scripts and APIs.

The management cloud 370 may detect and mitigate the effects of external influences, such as distributed denial-of-service (DDOS) attacks, on the BMC 102 or the host 180. By continuously monitoring the resource utilization (CPU, memory, I/O) of the BMC processes 214-1 to 214-N and the host processes 212-1 to 212-M, the management cloud 370 can identify abnormal behavior indicative of such attacks. For instance, a sudden spike in memory consumption by a process could signal an ongoing attack. The management cloud 370's response to such detections may be to issue warnings or take corrective actions, such as process restarts or adjustments to resource allocations, thereby preventing the system from being overwhelmed.

Furthermore, the management cloud 370 may correlate the state and behavior of the BMC processes 214-1 to 214-N and the host processes 212-1 to 212-M during runtime with the health of the hardware components. This correlation may help identify processes that exhibit problematic behavior, such as frequent crashes or excessive resource consumption. Once identified, the BMC 102 can make informed decisions to disable such processes to maintain system stability and performance.

The monitoring and management capabilities extend to the hardware level, where parameters like the CPU temperature, power wattage, and fan speed are closely observed. This is particularly important in scenarios where software processes significantly impact hardware health. For example, a process that excessively utilizes the CPU can cause an increase in temperature, necessitating increased fan speeds and resulting in higher power consumption. By correlating software process behavior with these hardware parameters, the management cloud 370 can take preemptive actions to adjust process priorities or resource allocations, thereby preventing hardware overuse and optimizing power efficiency.

Specifically, the management cloud 370 can select certain vendor deployed or administrator deployed processes that are of interest for monitoring. In contrast, the Linux base processes running on the host 180 may not need monitoring since they are known to work properly.

The management cloud 370 correlates the resource utilization data, such as CPU, memory, and I/O usage, of the selected BMC processes 214-1 to 214-N and host processes 212-1 to 212-M, along with physical sensor data from components like the CPU, memory, and I/O. The management cloud 370 calculates process stability based on available RAM and memory utilization. For example, if the BMC 102 has 1 GB RAM, and a BMC process uses 50% of the memory, it indicates an issue.

Furthermore, models can calculate hardware cooling requirements based on software application loads. For example, higher CPU loads can increase CPU temperature, requiring higher fan speeds.

By correlating process utilization data from the host 180 and BMC 102 with underlying hardware sensors, the system can identify issues before they escalate. Appropriate remediation actions can then be taken automatically through scripts and APIs invoked by the BMC 102.

Furthermore, a data collection agent, implemented through components such as the BMC process data collector 333-1, the BMC hardware data collector 333-2, and the host data collector 333-3 on the BMC 102, collects heuristic data about various parameters based on the data collection configuration set up through the data collection configuration manager 331. The data collection configuration can specify collection of parameters such as process states, resource utilization, fault statistics, hardware parameters, and network statistics for both BMC processes 214-1 to 214-N and host processes 212-1 to 212-M. This configuration, managed by the data collection configuration manager 331, allows for dynamic adjustments based on external inputs or system administrator preferences.

In addition, the data collection agent can be configured to collect information about specific storage groups or a particular process of interest to the administrator.

Further, the data collection agent may have two parts-one hosted on the BMC 102 itself through components such as the BMC process data collector 333-1 and BMC hardware data collector 333-2, and a second part hosted on the host 180 through components such as the host process data collector 311 and host data server 312. The BMC 102 and host 180 communicate collected data with each other over the host interface 320. The BMC-based data collection agent acts as an aggregator and correlator of the collected data.

The data collection agent can be configured to collect information about specific storage groups or processes of interest specified by the system administrator. For example, the data collection configuration manager 331 on the BMC 102 allows configuring the BMC process data collector 333-1, BMC hardware data collector 333-2, and host data collector 333-3 to collect data about particular BMC processes 214-1 to 214-N or host processes 212-1 to 212-M. This enables focused data collection about processes utilizing high resources or exhibiting stability issues.

Furthermore, if the system contains virtual machines (VMs), the data collection agent can also be installed on the guest VMs to collect application data. For example, the host data collector 333-3 may interface with a host process data collector 311 on the host 180 to gather data from guest VM applications.

The collection of data from multiple nodes across the BMC's will be used for creating a data model for different prediction models. The aggregation of data will be based on multiple subscribed telemetry reports to an analytics engine that will provide correlation information about multiple health parameter variables to a particular outcome.

The accuracy of the regression model will depend on the data set collected. The amount of data collected will be based on the number of nodes and the frequency of data collection. The parameters of data collection may be tuned based on the number of nodes it has at its disposal.

In this example, the BMC 102 acts as a master BMC to collect information from subordinate BMCs in a group. The BMC 102 provides a method for aggregating data collection across multiple BMCs 302-1 to 302-P to create predictive models. Specifically, the telemetry client 335 on the BMC 102 collects required data points from the BMCs 302-1 to 302-P based on a configured data correlation model.

The data correlation model may specify aggregation of parameters related to CPU utilization, temperature, fan speeds, and power usage from the BMCs 302-1 to 302-P to predict thermal issues. This aggregated data can then be input to regression models on the management cloud 370 to determine correlations.

The accuracy of the regression models depends on the volume of distinct data points collected from the BMC processes 214-1 to 214-N, the host processes 212-1 to 212-M, and/or the BMCs 302-1 to 302-P over time. Accordingly, the data collection configuration manager 331 allows tuning the data collection frequency and duration. Collecting data less frequently reduces overhead. However, collecting data more frequently and from more BMCs 302-1 to 302-P increases model accuracy.

Dynamic data models may be created based on usage scenarios of a particular data center context. The aggregator engine may require N distinct sets of data for a particular variable set. For example, a correlation between CPU utilization vs (CPU temperature, power wattage used, fan speed) may be provided. The user of the aggregation model can choose the probable regression models from the UI. The data aggregator can be tuned to either collect the data that is of particular interest or can be asked to collect all available telemetry report. A dynamic aggregation model may be provided based on user choice and creates regression models based on the usage.

The aggregated data from multiple BMCs 302-1 to 302-P and multiple hosts are useful for creating data models to detect issues and enable automatic remediation actions through scripts and APIs. As an example, by collecting data for parameters such as process crashes, CPU/memory utilization, and CPU temperature from multiple systems over time, models can be created to predict hardware cooling requirements based on software application loads on hosts.

Dynamic data models may be created based on admin-selected parameters at runtime. For example, the data collection configuration manager 331 communicates with the management cloud 370 to facilitate admin selections of logical parameters (process data) and physical parameters (sensor data) for correlation. Administrators are provided with the ability to determine correlation factors, enabling them to link process behavior with physical system data or a combination of physical and logical data. This flexibility allows for customized analysis tailored to specific administrative needs.

Based on the selected correlation factors, heuristic models are generated using regression analysis. These models predict potential issues based on process behavior over time, enabling preemptive actions to mitigate risks. For example, the BMC 102 components such as the BMC process data collector 333-1 and BMC hardware data collector 333-2 aggregate the selected data. The aggregated data may be input to regression models on the management cloud 370 for analysis and tuning. For example, if a process is predicted to become unstable based on its runtime history, the admin can take preemptive actions such as restarting it.

In this example, the data collection configuration manager 331 on the BMC 102 allows administrators to select logical parameters (software process data) and physical parameters (hardware sensor data) to correlate. For example, an administrator can choose to correlate CPU utilization with parameters such as temperature, power usage, and fan speeds.

Furthermore, the aggregator engine, implemented through components like the telemetry client 335 and report aggregator 337 on the BMC 102, collects the requisite dataset for the selected correlation factors from entities like the BMC processes 214-1 to 214-N, host processes 212-1 to 212-M, and BMCs 302-1 to 302-P (Section Aggregation).

The accuracy of regression models depends on having distinct datasets across parameters and entities over time. Accordingly, the data collection configuration manager 331 allows tuning the collection frequency and duration to ensure model accuracy.

In addition, the management cloud 370 provides flexibility for administrators to choose probabilistic regression models for the selected correlation factors. The aggregator engine can collect entire telemetry datasets or only data of interest to administrators to balance overhead vs. accuracy.

Based on the aggregated data for the chosen correlation parameters from entities like BMC processes 214-1 to 214-N and BMCs 302-1 to 302-P, the management cloud 370 creates dynamic regression models tied to specific data center usage contexts. For instance, an administrator may create a model correlating CPU utilization on hosts with power consumption.

Collection data may be modified from an external entity to enhance trained data model. For example, users can add cost data for a particular variable to derive cost analysis. That is, users may add external data such as cost information to enhance the trained data models used for analytics and correlations.

In particular, cost data associated with running processes on the host 180 cannot be directly collected from the host 180 or the BMC 102. However, enabling correlation of cost with utilization parameters provides additional insights. For example, the management cloud 370 may allow users to add cost data corresponding to the power consumption of the host 180 when specific processes of the host processes 212-1 to 212-M run. As an illustration, if the host 180 consumes 100 W when running a machine learning application, the user can assign a cost value of $X to this 100 W consumption by entering it into the management cloud 370.

Accordingly, the management cloud 370 provides flexibility for users to incorporate external data like cost as an additional variable in the aggregated data model. As shown in FIG. 3, the management cloud 370 receives inputs from components like the data collection configuration manager 331 on the BMC 102 to facilitate user selections of correlation factors.

As such, in addition to logical parameters (e.g. process utilization data) and physical parameters (e.g. sensor data), users can choose to add cost data as an additional correlation variable. The aggregator engine, implemented through the telemetry client 335 and report aggregator 337, subsequently collects the requisite cost data entered by the user along with utilization and sensor data.

This enables creation of holistic data models on the management cloud 370 that correlate cost, process performance, and hardware health. For instance, if a certain machine learning application on the host 180 causes high CPU utilization and temperature rises, the corresponding cost for this can be predicted.

Furthermore, correlating cost data with process utilization provides the ability to analyze the cost of running specific host processes 212-1 to 212-M. For example, the cost implications of running a host process at 10% vs 80% CPU utilization can be compared.

As discussed, the management cloud 370 provides capabilities for managing operating system resources on the host 180 based on notifications from the analytics engine. Specifically, the analytics engine, implemented in the management cloud 370, analyzes the collected and aggregated data and generates notifications when issues are predicted or detected. These notifications can trigger automatic adjustments to host operating system resources.

For example, the management cloud 370 may determine based on utilization and hardware sensor data that a particular host process (e.g. one of the host processes 212-1 to 212-M) is consuming excessive CPU resources, leading to rising temperatures. In response, the management cloud 370 can automatically reduce the CPU allocation for that process by interfacing with the host 180 OS kernel parameters through the BMC 102. Reducing the host process's CPU allocation allows mitigating the thermal issue without admin intervention.

Similarly, if the management cloud 370 detects a potential stability threat based on memory consumption metrics for a host process, it can trigger an OS level restart of the problematic process through the BMC 102. This enables self-healing capabilities at the host operating system layer based on analytics driven by the aggregated BMC data.

The facilities for enabling automated OS level resource tuning are provided by the host kernel. However, the intelligent analysis to drive the appropriate tuning actions is provided by the analytics engine within the management cloud 370. The BMC 102 provides the necessary APIs and interfaces for the management cloud 370 to invoke the requisite kernel level adjustments on the host 180.

Furthermore, the management cloud 370 allows the creation of scripts to automate common resource tuning actions, such as restarting a host process if its CPU usage exceeds a threshold. Based on the aggregated data, the management cloud 370 can automatically trigger configured scripts for remediation when appropriate conditions are met. This simplifies the automation process for administrators.

In this manner, the described solution enables closed-loop host operating system management driven by analytics on the telemetry data aggregated from various BMCs. The capabilities facilitate automated responses and mitigation actions for detected software stability or hardware health threats.

Furthermore, different data collection policies can be configured. For example, one BMC 102 can collect data from and manage a group of N subordinate BMCs 302-1 to 302-P. Alternatively, multiple BMCs 102 and 302-1 to 302-P can independently send data to the central management cloud 370. In both cases, the management cloud 370 leverages the aggregated data to analyze issues across entities like the BMC 102, subordinate BMCs 302-1 to 302-P, host 180 etc. Based on this analysis, it determines appropriate control actions to be taken on individual entities. The BMC 102 and 302-1 to 302-P provide the programmatic interfaces and APIs for the management cloud 370 to invoke these actions across managed entities.

The host 180 runs various customer applications and services such as databases, web servers etc. These are represented by the host processes 212-1 to 212-M. Since some of the host processes 212-1 to 212-M on the host 180 are in user space, there are restrictions on the level of data that can be collected, and the types of adjustments that can be made, from the management space through the BMC 102. The operating system on the host 180 is more restricted compared to the BMC 102 in terms of external management. The host 180 user space runs critical customer applications and workloads.

To enable managed data collection on the host 180 for the purposes of modeling and correlation, the host data collector 333-3 on the BMC 102 interfaces with the host process data collector 311 and the host data server 312 on the host 180 over the host interface 320. The host interface 320 may be implemented over USB, network, or other suitable communication technologies supported between the BMC 102 and host 180.

The host process data collector 311 on the host 180 collects data about the host processes 212-1 to 212-M per the configuration set up through the data collection configuration manager 331. This data is made available to the host data collector 333-3 on the BMC 102 through the host data server 312 over the host interface 320.

In addition, the host data collector 333-3 on the BMC 102 can interface with inband hardware data collection and drivers 313 on the host 180 to gather additional hardware data.

Furthermore, the host data collector 333-3 facilitates control actions on host processes 212-1 to 212-M such as restarting processes or tuning kernel parameters. The host data server 312 exposes the necessary APIs for the BMC 102 to invoke such host level control actions.

As described supra, the BMC 102 collects data about both the BMC processes 214-1 to 214-N running on the BMC 102 itself, as well as the host processes 212-1 to 212-M running on the host 180. Specifically, the service components 132 on the BMC 102 include the BMC process data collector 333-1 and the host data collector 333-3 to collect data about the BMC processes 214-1 to 214-N and the host processes 212-1 to 212-M respectively.

The collected data is aggregated into a table or data frame structure containing rows for each process (e.g., the BMC processes 214-1 to 214-N and the host processes 212-1 to 212-M) and columns for parameters of interest such as CPU, memory, or I/O utilization. By analyzing this aggregated data, administrators can monitor the runtime behavior of individual processes. For example, threshold-based alerts can be configured to detect abnormal resource consumption and automatically restart problematic processes.

Furthermore, the host data collector 333-3 interfaces with components on the host 180 such as the host process data collector 311 and host data server 312 over the host interface 320 to collect host process 212-1 to 212-M data.

In addition, the telemetry client 335 on the BMC 102 collects related data from other BMCs 302-1 to 302-P to aggregate at the BMC 102.

As such, the BMC 102 serves as a centralized data aggregation point for the host processes 212-1 to 212-M on the connected host 180, the BMC processes 214-1 to 214-N running locally on the BMC 102, as well as telemetry data from BMCs 302-1 to 302-P in the same group.

This aggregated data enables creation of holistic system health models using correlation and predictive analytics. Specifically, simple linear regression techniques can be utilized to detect anomalies and facilitate automatic remediation actions through scripts and APIs.

The flexible and extensible data aggregation architecture allows administrators to focus data collection on processes of interest (BMC processes 214-1 to 214-N or host processes 212-1 to 212-M). The volume of distinct data points over time can also be tuned to balance model accuracy with overhead.

The aggregation model allows flexibility in how data collection and aggregation is implemented across BMCs. Specifically, the system can have one master BMC 102 collecting data from and managing subordinate BMCs 302-1 to 302-P. Alternatively, multiple BMCs 102 and 302-1 to 302-P can independently collect and aggregate data by sending it directly to the central management cloud 370.

In the first model, the BMC 102 acts as the master node, aggregating data from the subordinate BMCs 302-1 to 302-P through its telemetry client 335. The aggregated data from the subordinate BMCs 302-1 to 302-P is further sent by the master BMC 102 to the management cloud 370 for analysis through components like the report aggregator 337.

In the distributed aggregation model, the BMCs 102 and 302-1 to 302-P independently collect data about their local BMC processes 214-1 to 214-N and host processes 212-1 to 212-M and send it directly to the management cloud 370 without going through an intermediary aggregator BMC. For example, the BMC process data collector 333-1, BMC hardware data collector 333-2, and host data collector 333-3 on each BMC 102 and 302-1 to 302-P gathers data and transmits it through the report aggregator 337 to the management cloud 370.

In both cases, the management cloud 370 provides centralized analytics capabilities leveraging aggregated data from various BMCs 102 and 302-1 to 302-P. Appropriate control actions determined based on the analytics can be targeted to specific BMCs 102 and 302-1 to 302-P or their associated hosts 180.

Furthermore, simple predictive models such as linear regression can be implemented based on the aggregated BMC data without needing complex AI algorithms. The focus is on collecting and correlating logical (software process) and physical (sensor) data from various BMCs 102 and 302-1 to 302-P to enable administrators to analyze system health holistically.

The system described here provides an infrastructure for collecting BMC and host process data, as well as hardware sensor data. The system also enables automated management of BMC and host processes based on analysis of the collected data.

Specifically, data is collected about the runtime state, resource utilization, and fault statistics of the BMC processes 214-1 to 214-N on the BMC 102 itself. Similarly, data is gathered about the host processes 212-1 to 212-M on the host 180 through components like the host process data collector 311.

In addition, hardware sensor data such as temperature, power usage, and fan speeds is collected from underlying components like the CPU by the BMC hardware data collector 333-2. Network statistics for the shared NIC 220 are also gathered when contention occurs between host and BMC processes.

This data is aggregated into table or frame structures containing rows for each monitored process and columns for parameters like CPU, memory, I/O usage, crashes etc.

By analyzing the aggregated data, issues can be predicted before they escalate. For example, thresholds can trigger alerts when abnormal resource consumption is detected for a process. Problematic processes can then be automatically restarted to avoid stability threats.

Specifically, aggregated data enables the creation of predictive models using simple regression techniques. These models facilitate closed-loop issue remediation through scripts and APIs invoked from the BMC 102. For example, the management cloud 370 models the correlation between software resources and hardware resources. The management cloud 370 utilizes data regarding process states, resource utilization (CPU, memory, I/O), process fault statistics, and hardware parameters (CPU temperature, power usage, fan speeds), among others. This data, once collected and aggregated, enables the creation of predictive models based on linear regression application models, as highlighted in the discussion. These models support the autonomic management infrastructure, allowing for the prediction of system behavior and the proactive management of resources.

The volume of distinct data points collected over time can be tuned to balance overhead with model accuracy. Data collection can also be focused on processes determined to be of interest rather than gathering exhaustive telemetry.

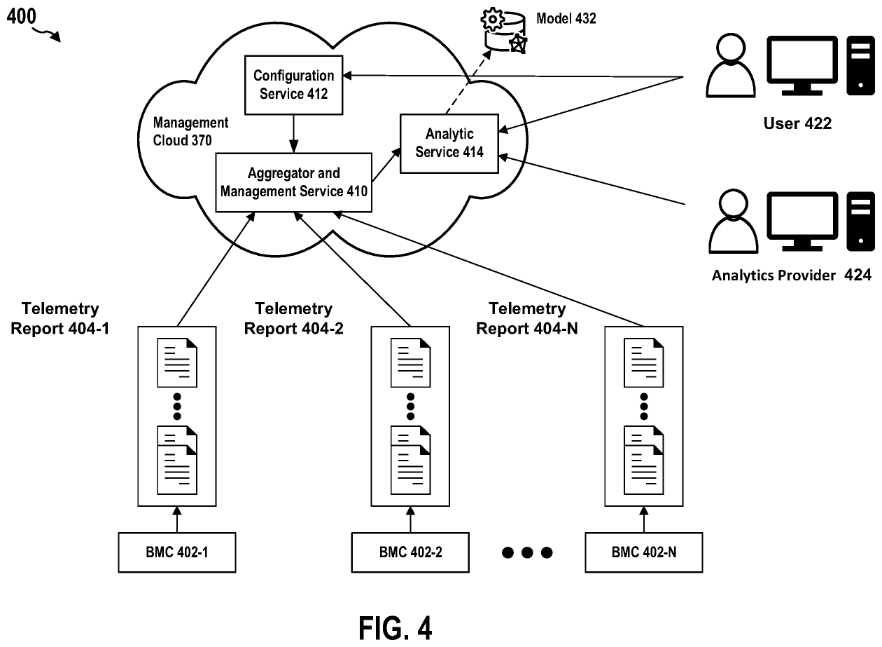

FIG. 4 is a diagram 400 illustrating a management cloud for data collection, aggregation, and correlation. The management cloud 370 facilitates flexible data collection, aggregation, correlation, and analytics. The management cloud 370 contains various services to enable administrators to customize analysis based on data gathered from entities such as BMCs 402-1, 402-2, . . . , 402-N, which may be the BMC 102 and subordinate BMCs 302-1 to 302-P. In particular, the management cloud 370 include an aggregator and management service 410, a configuration service 412, and an analytic service 414. Each service of in the management cloud 370 may be implement by a computer device having a structure similar to that of the host 180.

Specifically, the configuration service 412 allows administrators to select logical parameters (software process data) and physical parameters (hardware sensor data) to correlate. For example, a user 422 can choose to correlate power usage from sensor devices 468 with CPU temperature.

The configuration service 412 facilitates setting up data collection by interfacing with the data collection configuration manager 331 on the BMC 102. Based on admin-selected correlation factors, the BMC 102 components such as the BMC process data collector 333-1, BMC hardware data collector 333-2, and host data collector 333-3 aggregate the required data points.

In addition, the configuration service 412 allows users such as the user 422 to incorporate external data such as cost for more comprehensive analysis. The aggregated data is input to the analytic service 414 on the management cloud 370.

The aggregator and management service 410 subscribes to time series telemetry reports 404-1 to 404-N from the BMCs 402-1 to 402-N using REDFISH MetricReportDefinition schemas. For example, the user 422 configures telemetry data to be collected from one or more of the BMCs 402-1, 402-2, . . . , 402-N using the configuration service 412.

Utilizing the Redfish MetricReportDefinition schema, the system defines the metrics, periodicity, and transmission type for telemetry reports from individual BMCs. These reports, formatted as JSON documents, provide time-stamped data that is used for time series analysis. The aggregator and management service 410 compiles these individual reports into a holistic dataset that is then forwarded to the analytic service 414 for further processing.

The aggregator and management service 410 aggregates the individual telemetry reports 404-1 to 404-N into a holistic multi-variate dataset for the analytic service 414. The aggregated data in conjunction with external variables supplied by the user 422 allows creating rich analytic models 432 centered on admin-defined parameters.

The analytic service 414 employs various regression methods, including but not limited to step-wise and ridge regression, to analyze the multivariate data set. This analysis not only provides correlations, such as between power usage and CPU temperature, but also enables the prediction of future trends and behaviors based on historical data. By continuously refining the model 432 with new data, the system enhances its predictive accuracy, thereby facilitating more efficient system performance and optimized resource utilization.

The analytic service 414 performs predictive analysis via models 432 based on the aggregated multi-variate dataset. Multivariate linear regression models can identify correlations across software and hardware parameters over time. The analytics provider 424 may create and tunes the models 432 based on collected data accuracy. For instance, by gathering data on parameters such as CPU utilization and temperature from multiple BMCs 402-1 to 402-N, the model 432 can determine the relationship between software workloads and hardware cooling needs. The model 432 may analyze historical patterns in the data to predict future temperature changes based on expected software utilization.

The models 432 also facilitate cost analysis based on utilization data. The user 422 can incorporate cost data for a usage parameter like power consumption supplied by sensor devices 468. By correlating cost, software workloads, and sensor data, operating expenses for various applications can be predicted.

Overall, the management cloud 370 enables customizable correlation and analytics by allowing admins to select parameters of interest. Data is aggregated from entities like the BMC 102 and subordinate BMCs 302-1 to 302-P over desired time periods. The aggregated dataset fuels creation of analytic models 432 centered on discovering relationships in the data. These models facilitate predictive management by determining expected parameter values based on historical data.

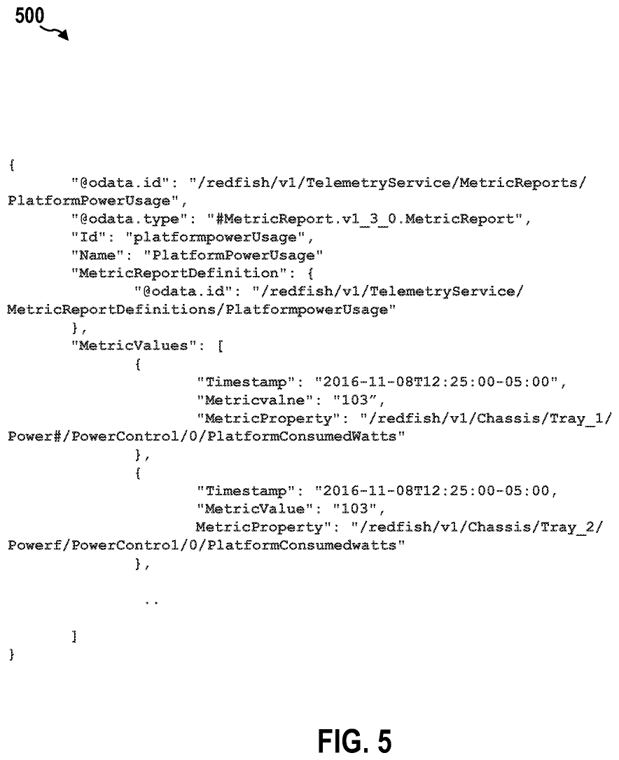

FIG. 5 is a diagram illustrating an exemplary REDFISH metric report 500. The metric report 500 contains time-stamped telemetry data collected by one or more the BMCs 402-1 to 402-N and may be an individual report from the metric reports 404-1 to 404-N.

Specifically, the metric report 500 contains metrics of platform power usages from multiple platforms. For example, the telemetry client 335 on the BMC 102 may collect telemetry data from the BMCs 302-1, 402-2, . . . , 302-P. Accordingly, the BMC 102 generates the metric report 500. The fields of the metric report 500 are as follows:
The “@odata.id” field specifies the unique resource identifier for the telemetry service's metric report on platform power usage, indicating the specific endpoint where the metric report can be accessed or queried.
The “@odata.type” field denotes the schema type for the metric report, ensuring consistency and standardization in how the data is structured and interpreted.
The “Id” and “Name” fields provide human-readable identifiers for the metric report, facilitating easier identification and reference by system administrators or automated management services, such as the aggregator and management service 410.
The “MetricReportDefinition” object references the definition for the metric report, which includes the criteria and parameters that define what data is collected, how it is processed, and how often it is updated.
The “Metric Values” array contains the actual data points collected by the system. Each object within this array includes:
A “Timestamp” indicating when the metric value was recorded, providing temporal context for the data.
A “Metric Value” representing the actual measurement or value recorded for the metric at the given timestamp.
A “MetricProperty” that specifies the system component or attribute to which the metric value corresponds, such as power consumption metrics for specific chassis trays.

As shown, the Timestamp field in the metric report 500 provides time series information to enable trend analysis. The Metric Value gives the sensor measurement, while the MetricProperty describes the specific hardware component being measured.

For instance, the metric report 500 shows platform power consumption data collected from the power supply units in Tray_1 and Tray_2 at a given point in time. By compiling such data from various components across multiple BMCs 402-1 to 402-N, rich analytics can be performed to correlate software workloads with hardware parameters.

Furthermore, data collected from individual BMCs 402-1 to 402-N is aggregated by the aggregator and management service 410 on the management cloud 370 to create a holistic data set. This facilitates building predictive models via the analytic service 414 to determine expected parameter values based on historical patterns.

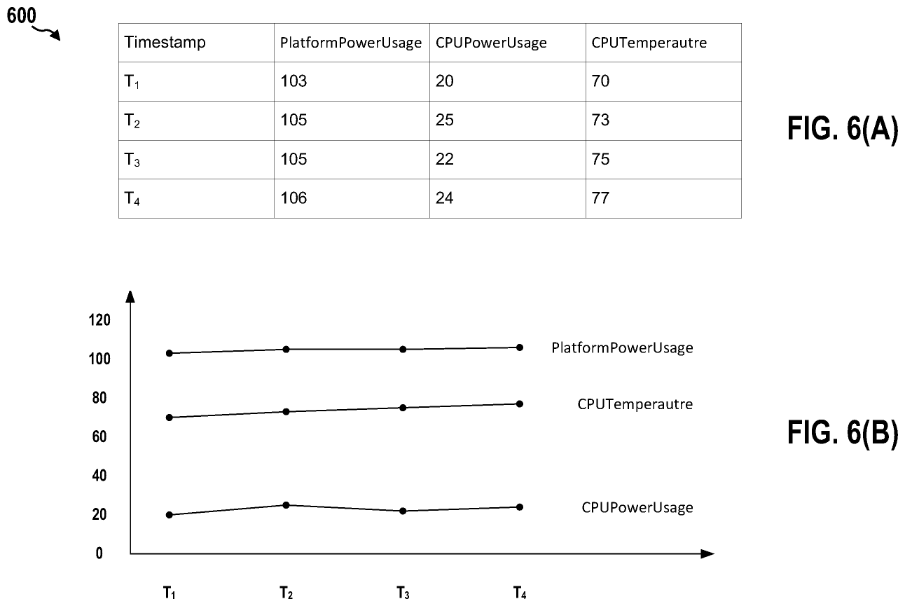

FIG. 6(A) is a diagram illustrating an example of a data frame 600 curated based on the time-stamped JSON data derived from a metric report. A data frame can be constructed from the JSON data in the metric reports gathered from various BMCs 402-1 to 402-N. In this example, the data frame 600 has columns capturing Timestamp, PlatformPowerUsage, CPUPowerUsage, and CPUTemperature information.

The rows of the data frame contain data points collected at different timestamps (T1, T2 etc.) by the telemetry client 335 across multiple BMCs 402-1 to 402-N, aggregated by the aggregator and management service 410. In this example, positive correlation exists between PlatformPowerUsage and CPUTemperature, indicating that CPU power usage and temperature rise together. Furthermore, as user-configurable cost data can be incorporated through the configuration service 412, rise in PlatformPowerUsage would also increase operational cost.

To enable more comprehensive correlation analysis, process utilization data can additionally be included in the data frame. Having process information would allow determining the specific software workloads responsible for increased CPU usage, temperature, power consumption and resultant cost.

The enhanced data set facilitates creating accurate predictive models via the analytic service 414 on the management cloud 370 to correlate software behaviors and hardware parameters. These models in turn drive automated issue remediation through scripts and APIs.

FIG. 6(B) is a diagram illustrating visualization of the aggregated data and correlations between parameters.

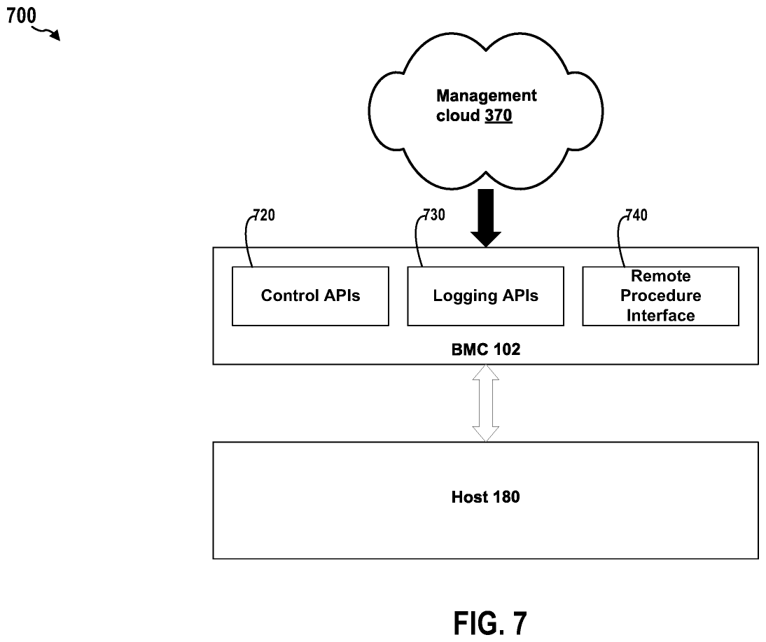

FIG. 7 is a diagram 700 illustrating device management and control. In this example, the BMC 102 manages the host 180 and is in communication with the management cloud 370. Further, the BMC 102 exposes control APIs 720, logging APIs 730, and a remote procedure interface 740.

The system described enables automated management of health parameters on the server nodes (hosts 180) and the baseboard management controllers (BMCs 102 and 302-1 to 302-P). The core capability is provided by the aggregator and management service 410 within the management cloud 370.

Specifically, the aggregator and management service 410 analyzes the aggregated data from entities such as the BMC 102 and subordinate BMCs 302-1 to 302-P. Based on predicted issues or anomalies detected in the data, the aggregator and management service 410 determines appropriate control actions to be taken and conveys them to the respective BMCs 102 and 302-1 to 302-P. The BMCs 102 and 302-1 to 302-P then facilitate enactment of the specified control actions on themselves or their associated hosts 180.

In one use case, thermal parameters, fan speed, and CPU throttling can be controlled by the aggregator and management service 410, which directs the BMC 102 or 302-1 to 302-P to perform certain actions through APIs.

Specifically, the aggregator and management service 410 analyzes the aggregated data from entities such as the BMC 102 and subordinate BMCs 302-1 to 302-P. Based on predicted issues or anomalies detected in the data, the aggregator and management service 410 determines appropriate control actions to be taken and conveys them to the respective BMCs 102 and 302-1 to 302-P. The BMCs 102 and 302-1 to 302-P then facilitate enactment of the specified control actions on themselves or their associated hosts 180.

As an exemplary scenario, if thermal projections based on workload data show rising temperatures, the aggregator and management service 410 may decide to increase the fan speed to control the temperature. This decision would be conveyed to the BMC 102 or respective subordinate BMC 302-1 to 302-P via the exposed control APIs 720. Specifically, the SetFanSpeed API can be invoked by the aggregator and management service 410 to adjust fan speeds.

If adjusting the fan speed does not lead to a decrease in temperature or otherwise resolve the issue, the next step could be to reduce workloads on the host 180 by reducing CPU allocations to host services and processes. This action can again be directed by the aggregator and management service 410 using a CPU allocation control API exposed by the BMC 102.

Such a procedural method leveraging APIs exposed by the BMC 102 may be defined to address different anomaly response scenarios. The aggregator and management service 410 can thereby facilitate closed-loop issue resolution by determining appropriate corrective actions based on analytics, directing the BMC 102 to carry out said actions via API calls, and iterating if the problem is not resolved.

In another use case, the aggregator and management service 410 controls power and redundancy management. In this example, the aggregator and management service 410 monitors and manages the power consumption and redundancy mechanisms of the host 180 and associated hardware components.

The aggregator and management service 410 actively monitors the power usage of the host 180 and its components. By analyzing data collected on CPU utilization, memory usage, and other resource metrics, the aggregator and management service 410 can make informed decisions to optimize power consumption. For instance, during periods of low demand, the aggregator and management service 410 can reduce power allocation to non-critical components, thereby conserving energy without impacting performance.

Further, the aggregator and management service 410 may oversee redundancy protocols, such as failover mechanisms for critical components. By continuously monitoring the health and status of these components, the aggregator and management service 410 can preemptively initiate failover procedures in response to detected failures or degradation, ensuring uninterrupted service.

In yet another use case, the aggregator and management service 410 controls BMC process management. The system provides capabilities for controlling BMC process management based on the aggregated data analysis. Specifically, the management cloud 370 can detect issues with processes running on the BMC 102 itself and take appropriate corrective actions through the BMC 102's exposed interfaces.

For example, the introduction of a new application or feature on the BMC 102 may result in a BMC process such as one of the BMC processes 214-1 to 214-N consuming excessive resources. By monitoring process parameters like CPU and memory utilization, such abnormal behavior can be identified by the management cloud 370.

The management cloud 370 may then convey directives to institute corrective actions such as restarting or throttling the problematic BMC process by interfacing with the BMC 102 through the control APIs 720. Alternatively, the management cloud 370 can instruct the BMC 102 to run certain scripts to handle the issue through the remote procedure interface 740. This enables self-correction of stability issues with BMC processes 214-1 to 214-N in an automated manner. The analysis of aggregated data facilitates early detection of anomalies. The BMC 102's exposed programmatic interfaces allow the management cloud 370 to implement remediations proactively.

The operational workflow for controlling BMC process management can be summarized as follows:
Data about BMC processes (e.g., CPU usage, memory consumption, process states) is collected by the BMC process data collector 333-1.
This data is configured through the data collection configuration manager 331 based on the administrator's requirements.
Collected data is aggregated and analyzed by the management cloud 370, utilizing services like the aggregator and management service 410 and the analytic service 414.
Based on the analysis, decisions are made regarding the management of BMC processes. This could involve adjusting process priorities, restarting problematic processes, or altering resource allocations.
Management actions are executed through control interfaces, leveraging the control APIs 720, the logging APIs 730, and the remote procedure interface 740.

In another use case, the aggregator and management service 410 controls the host process management. In this example, the aggregator and management service 410 manages the host processes 212-1 to 212-M running on the host 180. Specifically, the management cloud 370 performs analytics on the aggregated data from entities such as the BMC 102 and subordinate BMCs 302-1 to 302-P to detect issues with the host processes 212-1 to 212-M. Upon detecting problems, the management cloud 370 determines appropriate control actions and instructs the BMC 102 to carry out said actions on the host 180.

For example, the management cloud 370 may identify that a particular host process is consuming excessive CPU resources based on the telemetry data, resulting in rising temperatures on the host 180. In response, the management cloud 370 can interface with the BMC 102 to reduce the CPU allocation for that problematic host process, thereby mitigating the thermal issue.

The management cloud 370 leverages exposed interfaces like the control APIs 720 on the BMC 102 to invoke such corrective actions on the host 180. Alternatively, the management cloud 370 can direct the BMC 102 to execute scripts that implement the desired controls through the remote procedure interface 740.

In this manner, the system enables closed-loop remediation of host process issues by:
Performing analytics on aggregated data from BMC 102 and subordinate BMCs 302-1 to 302-P in the management cloud 370
Detecting host process problems based on the analytics
Determining appropriate control actions (e.g. restarting processes, adjusting resource allocations)
Instructing the BMC 102 to implement said actions on the host 180
Utilizing interfaces like control APIs 720 and remote procedure interface 740 exposed by the BMC 102 to enact the corrective actions on the host 180

This enables capabilities such as automated host process restarts upon detected stability threats, thereby improving system resilience and availability. The aggregated data analytics facilitate early problem detection, while the BMC 102 provides the necessary hooks for the management cloud 370 to implement remediations proactively.

In another use case, the aggregator and management service 410 may control log collection. Log collection is an important capability to understand issues detected with processes on the host 180 or BMC 102. Specifically, if the management cloud 370 identifies misbehaving processes based on the aggregated data analysis, further debugging is required to determine the root cause.

To facilitate this, the system provides functionality for log collection and transmission from both the host 180 and BMC 102. The logging APIs 730 exposed by the BMC 102 allow the management cloud 370 to gather and transmit relevant logs via protocols such as email.

The management cloud 370 may detect frequent crashes with one of the host processes 212-1 to 212-M based on the telemetry data. To further diagnose the failure, the management cloud 370 can leverage the logging APIs 730 to collect the operating system logs from the host 180 that contain information about the crashing host process. These logs can then be sent to an administrator via email for offline analysis.

Similarly, the logging APIs 730 allow gathering debug logs for the BMC processes 214-1 to 214-N running on the BMC 102 itself. If issues are detected with a BMC process based on monitored parameters like CPU utilization and process faults, the relevant BMC logs can be collected by the management cloud 370 through the logging APIs 730. As with the host processes, these BMC logs can then be transmitted over email or other protocols to facilitate further debugging.

By providing mechanisms to easily collect and disseminate system logs from both the host 180 and BMC 102, the system enables better diagnosis of process-related issues identified via the telemetry analytics. The logging APIs 730 give the management cloud 370 the necessary hooks to extract further context and details around problems signaled in the aggregated data. Transmitting these logs over email bridges the gap between automated telemetry analytics and manual log-based debugging.

As described supra, the BMC can expose various interfaces to enable the management cloud 370 to implement automated control actions determined based on analytics.

These interfaces on the BMC 102 include:
Control APIs 720: These APIs allow the management cloud 370 to invoke specific actions on the BMC 102 itself or the connected host 180. For example, based on rising temperature predictions, the aggregator and management service 410 in the management cloud 370 can call a SetFanSpeed API exposed by the BMC 102 to increase fan speeds. Similarly, a CPU throttling API can be called to reduce CPU allocations for a problematic host process. The control APIs 720 enable enactment of closed-loop issue remediation by the management cloud 370.
Logging APIs 730: These APIs facilitate the collection of log data from the BMC 102 and host 180 by the management cloud 370. For instance, the aggregator and management service 410 may retrieve logs pertaining to a frequently crashing BMC process 214-1 to 214-N using the logging APIs 730 to debug the issue. The logging APIs 730 allow the management cloud 370 to gather additional context for detected anomalies.
Remote procedure interface 740: This interface enables the management cloud 370 to direct the execution of more complex automated management scripts on the BMC 102. For example, instead of calling specific control APIs, the aggregator and management service 410 can instruct the BMC 102 to run pre-defined scripts that restart a host process if its memory consumption exceeds a threshold. The remote procedure interface 740 provides flexibility to implement common management workflows.

The control APIs 720 allow precise and targeted control actions from the management cloud 370; logging APIs 730 facilitate gathering additional context for issues; and the remote procedure interface 740 permits scripted workflows for common management scenarios.

By exposing these interfaces, the BMC 102 enables the management cloud 370 to enact automated anomaly remediation determined based on analytics on the holistic data set gathered from entities such as BMCs 102, 302-1 to 302-P and hosts 180. The management cloud 370 detects issues early via data correlations and models. The BMC interfaces then permit closed-loop corrections by the management cloud 370 directed at the source of the issue, i.e., specific BMC 102/302-1 to 302-P processes or host 180 processes.

Further, scripts may be pushed to the BMC 102 for processing based on detected issues or anomalies. Specifically, the management cloud 370 can direct the BMC 102 to execute scripts that implement desired control actions through the remote procedure interface 740.

For example, if the analytic service 414 predicts a thermal issue based on rising CPU temperatures, the aggregator and management service 410 may decide to mitigate this by reducing host process workloads. Accordingly, the management cloud 370 can push a script to the BMC 102 via the remote procedure interface 740 to throttle CPU allocation for specific host processes 212-1 to 212-M.

However, to ensure security and integrity, any scripts sent to the BMC 102 for execution must be signed using corresponding signatures. That is, the script should have verifiable credentials from an authorized provider such as the user 422. The BMC 102 will validate the signature on a script before accepting it for execution through the remote procedure interface 740.

This secure script execution workflow may be as follows:
The analytic service 414 predicts an issue based on aggregated BMC data analysis
The aggregator and management service 410 determines that a script needs to be executed on the BMC 102 to implement corrective actions
The management cloud 370 sends the script to the BMC 102 via the remote procedure interface 740
The BMC 102 verifies the signature on the script to ensure it is from an authorized provider
Upon signature validation, the BMC 102 executes the script through the remote procedure interface 740
The script facilitates automated remediation (e.g. throttling host process CPU allocation)

Signed script execution through the remote procedure interface 740 provides flexibility to implement customized management logic on the BMC 102 as needed. However, for enhanced security, direct invocation of control APIs 720 exposed by the BMC 102 may be used over reliance on externally pushed scripts. The control APIs 720 allow verified programmatic access for implementing corrective actions.

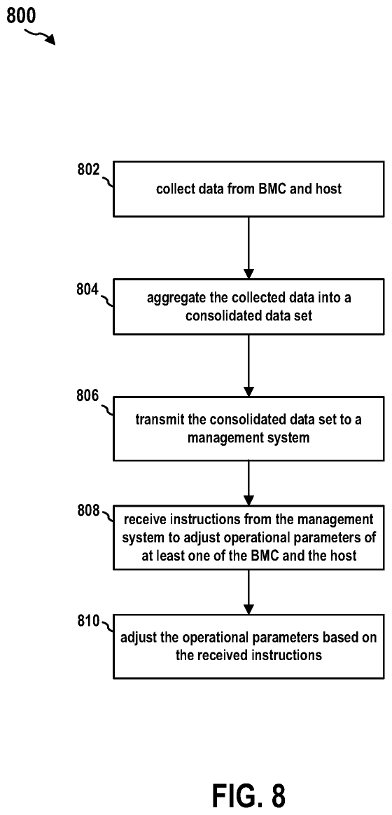

FIG. 8 is a flow chart 800 of a method for managing a computer system. The method may be performed by a BMC, such as BMC 102. In operation 802, the BMC collects at least one of data related to one or more processes executed on the BMC, data related to one or more processes executed on a host coupled to the BMC, data related to resource allocation at the BMC, data related to resource allocation at the host, fault statistics at the BMC, fault statistics at the host, network statistics at the BMC, network statistics at the host, hardware sensor data at the BMC, and hardware sensor data at the host.

In certain configurations, the collection is based on a collection configuration set by a management system, such as management cloud 370. In certain configurations, the collection includes collecting data about particular processes executed on at least one of the BMC and the host based on input from a system administrator, such as user 422. In certain configurations, the collection includes collecting first data related to processes executed on the BMC and resource allocation at the BMC and collecting second data related to processes executed on the host and resource allocation at the host. The first data and the second data are aggregated into the consolidated data set. In certain configurations, the BMC interfaces with a host data collector on the host over a host interface to collect data about processes executed on the host. In certain configurations, the BMC collects related data from one or more other BMCs coupled to corresponding hosts.

In operation 804, the BMC aggregates the collected data into a consolidated data set. In operation 806, the BMC transmits the consolidated data set to a management system, such as management cloud 370. In operation 808, the BMC receives instructions from the management system to adjust operational parameters of at least one of the BMC and the host. In operation 810, the BMC adjusts the operational parameters based on the received instructions. The instructions to adjust operational parameters include at least one of: increasing fan speeds; reducing CPU allocations; restarting processes; adjusting process priorities; adjusting resource allocations; initiating redundancy protocols; collecting log data; and transmitting log data.

In certain configurations, the BMC receives a script from the management system via a remote procedure interface. The BMC verifies a signature on the script. The BMC executes the script to implement adjustments to the operational parameters.

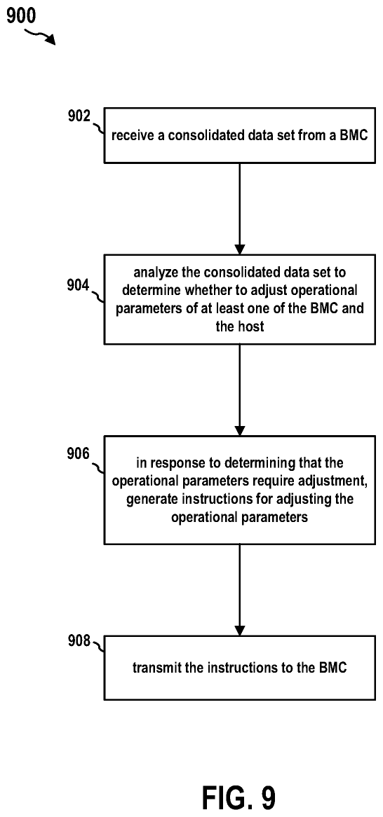

FIG. 9 is a flow chart 900 of another method for managing a computer system. The method may be performed by a management system, such as the management cloud 370 in FIG. 4.

In operation 902, the management system receives a consolidated data set from a BMC. The consolidated data set includes at least one of data related to one or more processes executed on the BMC, data related to one or more processes executed on a host coupled to the BMC, data related to resource allocation at the BMC, data related to resource allocation at the host, fault statistics at the BMC, fault statistics at the host, network statistics at the BMC, network statistics at the host, hardware sensor data at the BMC, and hardware sensor data at the host.

In operation 904, the management system analyzes the consolidated data set to determine whether to adjust operational parameters of at least one of the BMC and the host.

In operation 906, in response to determining that the operational parameters require adjustment, the management system generates instructions for adjusting the operational parameters.

In operation 908, the management system transmits the instructions to the BMC.

In certain configurations, the management system provides a configuration interface to enable configuration of data collection at the BMC. The configuration interface allows configuring the BMC to collect data about particular processes executed on at least one of the BMC and the host.

In certain configurations, the management system receives related data sets from a plurality of BMCs, aggregates the related data sets from the plurality of BMCs, and analyzes the aggregated data sets to determine whether to adjust operational parameters of at least one of the plurality of BMCs or respective hosts coupled to the plurality of BMCs.

In certain configurations, the management system receives external data from a user and incorporating the external data into the analysis for determining whether to adjust operational parameters. The external data comprises cost data relating operational parameters to financial costs.

In certain configurations, to analyze the consolidated data set, the management system applies at least one machine learning algorithm to the consolidated data set to determine expected values for operational parameters based on historical patterns.

In certain configurations, the instructions to adjust operational parameters include at least one of: increasing fan speeds, reducing CPU allocations, restarting processes, adjusting process priorities, adjusting resource allocations, initiating redundancy protocols, collecting log data, and transmitting log data.

In certain configurations, the management system transmits a script to the BMC via a remote procedure call interface to adjust the operational parameters. The management system signs the script prior to transmission. The BMC is configured to validate the signature prior to executing the script.

In certain configurations, to analyze the consolidated data set includes, the management system applies one or more predictive models to predict future system behavior based on historical data patterns within the consolidated data set.

In certain configurations, the management system utilizes a configuration service within the management system to enable dynamic selection of data aggregation models and predictive analysis models based on user-defined criteria.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim clement is to be construed as a means plus function unless the clement is expressly recited using the phrase “means for.”

What is claimed is:

1. A method of computer system management by a baseboard management controller (BMC), comprising:
collecting at least one of:
data related to one or more processes executed on the BMC,
data related to one or more processes executed on a host coupled to the BMC,
data related to resource allocation at the BMC,
data related to resource allocation at the host,
fault statistics at the BMC,
fault statistics at the host,
network statistics at the BMC,
network statistics at the host,
hardware sensor data at the BMC, and
hardware sensor data at the host;
aggregating the collected data into a consolidated data set;
transmitting the consolidated data set to a management system;
receiving instructions from the management system to adjust operational parameters of at least one of the BMC and the host; and
adjusting the operational parameters based on the received instructions.

2. The method of claim 1, wherein the collection is based on a collection configuration set by the management system.

3. The method of claim 1, wherein the collection comprises collecting data about particular processes executed on at least one of the BMC and the host based on input from a system administrator.

4. The method of claim 1, wherein the collection comprises:
collecting first data related to processes executed on the BMC and resource allocation at the BMC; and
collecting second data related to processes executed on the host and resource allocation at the host, wherein the first data and the second data are aggregated into the consolidated data set.

5. The method of claim 1, further comprising:
interfacing with a host data collector on the host over a host interface to collect data about processes executed on the host.

6. The method of claim 1, further comprising:
collecting related data from one or more other BMCs coupled to corresponding hosts.

7. The method of claim 1, wherein the instructions to adjust operational parameters include at least one of:
increasing fan speeds;
reducing CPU allocations;
restarting processes;
adjusting process priorities;
adjusting resource allocations;
initiating redundancy protocols;
collecting log data; and
transmitting log data.

8. The method of claim 1, further comprising:
receiving a script from the management system via a remote procedure interface;
verifying a signature on the script; and
executing the script to implement adjustments to the operational parameters.

9. A method of computer system management by a management system, comprising:
receiving a consolidated data set from a baseboard management controller (BMC), the consolidated data set including at least one of
data related to one or more processes executed on the BMC,
data related to one or more processes executed on a host coupled to the BMC,
data related to resource allocation at the BMC,
data related to resource allocation at the host,
fault statistics at the BMC,
fault statistics at the host,
network statistics at the BMC,
network statistics at the host,
hardware sensor data at the BMC, and
hardware sensor data at the host;
analyzing the consolidated data set to determine whether to adjust operational parameters of at least one of the BMC and the host;
in response to determining that the operational parameters require adjustment, generating instructions for adjusting the operational parameters; and
transmitting the instructions to the BMC.

10. The method of claim 9, further comprising:
providing a configuration interface to enable configuration of data collection at the BMC.

11. The method of claim 10, wherein the configuration interface allows configuring the BMC to collect data about particular processes executed on at least one of the BMC and the host.

12. The method of claim 9, further comprising:
receiving related data sets from a plurality of BMCs;
aggregating the related data sets from the plurality of BMCs; and
analyzing the aggregated data sets to determine whether to adjust operational parameters of at least one of the plurality of BMCs or respective hosts coupled to the plurality of BMCs.

13. The method of claim 9, further comprising:
receiving external data from a user; and
incorporating the external data into the analysis for determining whether to adjust operational parameters.

14. The method of claim 13, wherein the external data comprises cost data relating operational parameters to financial costs.

15. The method of claim 9, wherein analyzing the consolidated data set comprises applying at least one machine learning algorithm to the consolidated data set to determine expected values for operational parameters based on historical patterns.

16. The method of claim 9, wherein the instructions to adjust operational parameters include at least one of:
increasing fan speeds;
reducing CPU allocations;
restarting processes;
adjusting process priorities;
adjusting resource allocations;
initiating redundancy protocols;
collecting log data; and
transmitting log data.

17. The method of claim 9, further comprising:
transmitting a script to the BMC via a remote procedure call interface to adjust the operational parameters.

18. The method of claim 17, further comprising:
signing the script prior to transmission; and
wherein the BMC is configured to validate the signature prior to executing the script.

19. The method of claim 9, wherein analyzing the consolidated data set includes applying one or more predictive models to predict future system behavior based on historical data patterns within the consolidated data set.

20. The method of claim 9, further comprising:
utilizing a configuration service within the management system to enable dynamic selection of data aggregation models and predictive analysis models based on user-defined criteria.
